(19) United States
(12) Patent Application Publication
(10) Pub. No.: US 2007/0165751 A1
(43) Pub. Date: Jul. 19, 2007

(54) Symbol point estimating apparatus, method, program, and recording medium

(75) Inventor: Kenji Nowara, Saitama (JP)

Correspondence Address: GREENBLUM & BERNSTEIN, P.L.C., 1950 ROLAND CLARKE PLACE, RESTON, VA, 20191, US

(73) Assignee: Advantest Corporation, Tokyo (JP)

(21) Appl. No.: 10/577,254

(22) PCT Filed: Oct. 27, 2004
(86) PCT No.: PCT/JP04/16281

§ 371 Date: Jul. 12, 2006

(30) Foreign Application Priority Data
Oct. 29, 2003 (JP) 2003-368470

(51) Int. Cl. H04L 27/06

(52) U.S. Cl. 375/344

(57) ABSTRACT

The symbol points of a received signal can be more precisely measured. A symbol point estimating apparatus, which estimates the symbol points of a received signal z(k) by deciding a time delay T between sampling points of the received signal z(k) as sampled at a sampling frequency fs and the symbol points of the received signal z(k), comprises a multiplication/sum of products output unit for outputting a sum of products Ae^{jθ} of respective products Y(n)=Z(n)R(n)* obtained by multiplying a complex conjugate R(n)* of a frequency component R(n) of an ideal signal r(k) by a frequency component Z(n) of the received signal z(k) and a sampling angular frequency Δω(=2πfs/N, where N is an error component calculation length between the ideal signal r(k) and the received signal z(k)); and a time delay determining unit for determining, based on the output of the multiplication/sum of products output unit, the time delay T such that an error component EVM between the ideal signal r(k) and the received signal z(k) is minimized.

### TECHNICAL FIELD

The present invention relates to estimation of symbol points of a signal.

### BACKGROUND ART

There have conventionally been practiced demodulation of a received signal and modulation analysis of a received signal. On this occasion, it is necessary to precisely measure symbol points of the signal. The measurement of the symbol points of the received signal requires steps including: (1) A/D conversion of the received signal, (2) filtering to remove noises, (3) extraction of a symbol rate component, (4) calculation of a phase, and (5) conversion of the phase to a time delay (refer to a patent document 1 (Japanese Laid-Open Patent Publication (Kokai) No. 2003-152816), for example).

However, according to the above prior art, if the filter used to remove the noises has an adverse effect on frequency characteristics of the received signal, the symbol points of the signal cannot be precisely measured. Moreover, it is necessary to carry out over sampling for the A/D conversion of the received signal to prevent aliasing, and there thus increase a memory capacity required to record the results of the A/D conversion of the received signal.

It is an object of the present invention to more precisely measure symbol points of a received signal.

### DISCLOSURE OF THE INVENTION

According to an aspect of the present invention, a symbol point estimating apparatus that estimates a symbol point of a received signal by determining a time delay between a sampling point of the received signal sampled at a sampling frequency, and the symbol point of the received signal, includes: a multiplication/sum of products output unit that outputs a sum of products of respective products obtained by multiplying a complex conjugate of a frequency component of an ideal signal and a frequency component of the received signal and a sampling angular frequency; and a time delay determining unit that determines a time delay to minimize an error component between the ideal signal and the received signal based on the output of the multiplication/sum of products output unit.

According to the thus constructed symbol point estimating apparatus, a symbol point estimating apparatus that estimates a symbol point of a received signal by determining a time delay between a sampling point of the received signal sampled at a sampling frequency, and the symbol point of the received signal can be provided.

The multiplication/sum of products output unit outputs a sum of products of respective products obtained by multiplying a complex conjugate of a frequency component of an ideal signal and a frequency component of the received signal and a sampling angular frequency. The time delay determining unit determines a time delay to minimize an error component between the ideal signal and the received signal based on the output of the multiplication/sum of products output unit.

According to the present invention, the multiplication/sum of products output unit may include: a frequency component product output unit that outputs the product of the complex conjugate of the frequency component of the ideal signal and the frequency component of the received signal; and a sum of products output unit that outputs the sum of products of the respective outputs of the frequency component product output unit and the sampling angular frequency.

According to the present invention, the frequency component product output unit may include: an ideal signal frequency component output unit that outputs the frequency component of the ideal signal; a received signal frequency component output unit that outputs the frequency component of the received signal; a complex conjugate output unit that outputs the complex conjugate of the output of the ideal signal frequency component output unit; and a frequency component product output unit that multiplies the output of the complex conjugate output unit and the output of the received signal frequency component output unit by each other, and then outputs a result of the multiplication.

According to the present invention, the frequency component product output unit may include: a convolution output unit that outputs a convolution of the complex conjugate of the ideal signal and the received signal; and a frequency component output unit that outputs a frequency component of the output of the convolution output unit.

According to the present invention, the sum of products output unit may include: a real part sum of products output unit that outputs a sum of products of the real part of the respective outputs of the frequency component product output unit and the sampling angular frequency; an imaginary part sum of products output unit that outputs a sum of products of the imaginary part of the respective outputs of the frequency component product output unit and the sampling angular frequency; and a complex number output unit that outputs a complex number whose real part is the output of the real part sum of products output unit and whose imaginary part is the output of the imaginary part sum of products output unit.

According to the present invention, the time delay determining unit may determine the time delay based on the argument of the output of the multiplication/sum of products output unit, the sampling angular frequency, and an error calculation length which is the number of the components of the received signal used to calculate the error component.

According to the present invention, the time delay determining unit may include: an argument output unit that receives the output of the multiplication/sum of products output unit, and outputs the argument thereof; and a time delay calculating unit that calculates the time delay based on the output of the argument output unit, the sampling angular frequency, and the error calculation length.

Another aspect of the present invention is a symbol point estimating method that estimates a symbol point of a received signal by determining a time delay between a sampling point of the received signal sampled at a sampling frequency, and the symbol point of the received signal, including: a multiplication/sum of products output step of outputting a sum of products of respective products obtained by multiplying a complex conjugate of a frequency component of an ideal signal and a frequency component of the received signal and a sampling angular frequency; and a time delay determining step of determining a time delay to minimize an error component between the ideal signal and the received signal based on the output of the multiplication/sum of products output step.

Another aspect of the present invention is a program of instructions for execution by the computer to perform a symbol point estimating process that estimates a symbol point of a received signal by determining a time delay between a sampling point of the received signal sampled at a sampling frequency, and the symbol point of the received signal, the symbol point estimating process including: a multiplication/sum of products output step of outputting a sum of products of respective products obtained by multiplying a complex conjugate of a frequency component of an ideal signal and a frequency component of the received signal and a sampling angular frequency; and a time delay determining step of determining a time delay to minimize an error component between the ideal signal and the received signal based on the output of the multiplication/sum of products output step.

Another aspect of the present invention is a computer-readable medium having a program of instructions for execution by the computer to perform a symbol point estimating process that estimates a symbol point of a received signal by determining a time delay between a sampling point of the received signal sampled at a sampling frequency, and the symbol point of the received signal, the symbol point estimating process including: a multiplication/sum of products output step of outputting a sum of products of respective products obtained by multiplying a complex conjugate of a frequency component of an ideal signal and a frequency component of the received signal and a sampling angular frequency; and a time delay determining step of determining a time delay to minimize an error component between the ideal signal and the received signal based on the output of the multiplication/sum of products output step.

### BRIEF DESCRIPTION OF THE DRAWINGS

FIG. 1 is a block diagram showing a configuration of a symbol point estimating apparatus 1 according an embodiment of the present invention FIG. 2 is a diagram showing an EVM, which is an error component between an ideal signal r(k) and a received signal z(k);

FIG. 3 is a diagram showing a configuration of a frequency component product output unit 12;

FIG. 4 is a diagram showing a variation of the configuration of the frequency component product output unit 12;

FIG. 5 is a diagram showing a configuration of a sum of products output unit 14; and

FIG. 6 is a diagram showing a configuration of a time delay determining unit 20.

### BEST MODE FOR CARRYING OUT THE INVENTION

A description will now be given of a best mode to carry out the present invention with reference to drawings.

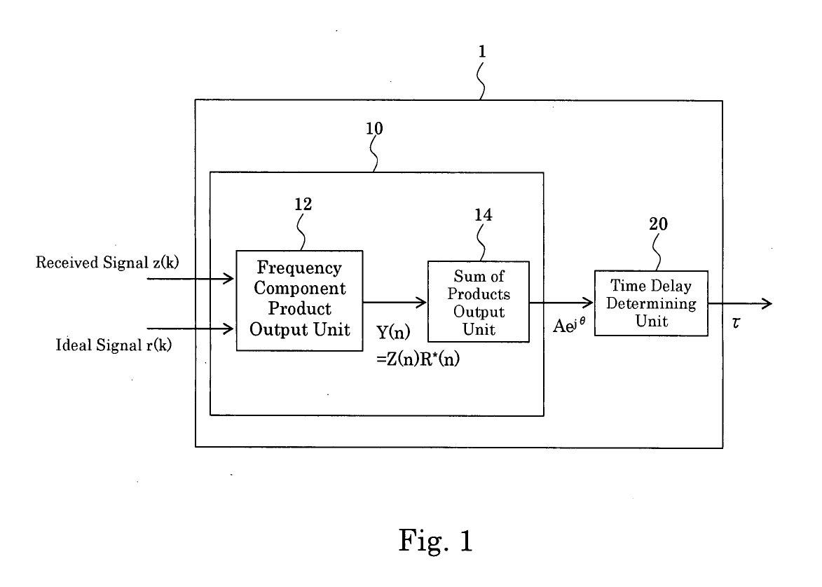

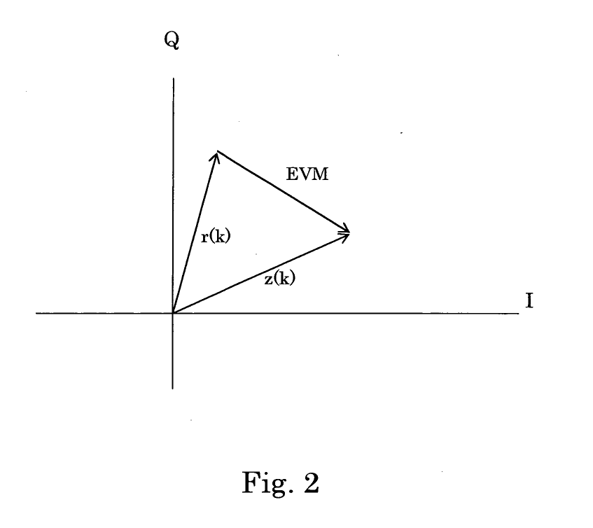

FIG. 1 is a block diagram showing a configuration of a symbol point estimating apparatus 1 according an embodiment of the present invention. The symbol point estimating apparatus 1 is used to estimate symbol points of a received signal z(k). The estimation of the symbol points enables demodulation of the received signal z(k) and modulation analysis of the received signal z(k). The estimation of the symbol points of the received signal z(k) is carried out by determining a time delay τ between sampling points of the received signal z(k) sampled at a sampling frequency fs and the symbol points of the received signal z(k).

The symbol point estimating apparatus 1 includes a multiplication/sum of products output unit 10 and a time delay determining unit 20.

The multiplication/sum of products output unit 10 outputs a sum of products Ae^{j}^{^{θ}} of respective products Y(n)=Z(n)R(n)* obtained by multiplying a complex conjugate R(n)* of a frequency component R(n) of an ideal signal r(k) and a frequency component Z(n) of the received signal z(k) by each other, and a sampling angular frequency Δω(=2πfs/N). It should be noted that N denotes an EVM calculation length. Moreover, the ideal signal r(k) is generated from the received signal z(k). It should be noted that EVM (Error Vector Magnitude) is an error component between the ideal signal r(k) and the received signal z(k) as shown in FIG. 2. The EVM is defined by the following equation (1). It should be noted that N denotes the EVM calculation length.

$$\begin{matrix}[ EQU . 1 ] & \\ EVM = \sqrt{\frac{{\sum }_{k = 0}^{N - 1} {\vert {z}_{k} - {r}_{k} \vert}^{2}}{{\sum }_{k = 0}^{N - 1} {\vert {r}_{k} \vert}^{2}}} \times 100 [ \% rms ] & ( 1 )\end{matrix}$$

The multiplication/sum of products output unit 10 includes a frequency component product output unit 12, and a sum of products output unit 14.

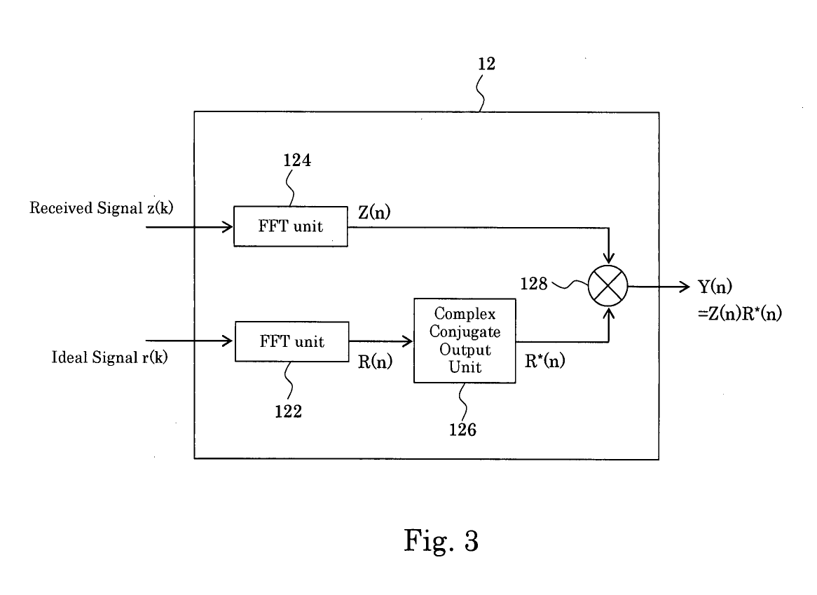

The frequency component product output unit 12 outputs a product Y(n)=Z(n)R(n)* of a complex conjugate R(n)* of a frequency component R(n) of the ideal signal r(k) and the frequency component Z(n) of the received signal z(k). A configuration of the frequency component product output unit 12 is shown in FIG. 3. The frequency component product output unit 12 includes an FFT unit (ideal signal frequency component output means) 122, an FFT unit (received signal frequency component output means) 124, a complex conjugate output unit 126, and a multiplier (frequency component product output means) 128.

The FFT unit (ideal signal frequency component output means) 122 applies the FFT (Fast Fourier Transform) to the ideal signal. r(k), and outputs a result thereof. The result of the FFT applied to the ideal signal r(k) is the frequency component R(n) of the ideal signal r(k).

The FFT unit (received signal frequency component output means) 124 applies the FFT (Fast Fourier Transform) to the received signal z(k), and outputs a result thereof. The result of the FFT applied to the received signal z(k) is the frequency component Z(n) of the received signal z(k).

The complex conjugate output unit 126 outputs the complex conjugate R(n)* of the output R(n) of the FFT unit (ideal signal frequency component output means) 122.

The multiplier (frequency component product output means) 128 multiplies the output R(n)* of the complex conjugate output unit 126 and the output Z(n) of the FFT unit (received signal frequency component output means) 124 by each other, and outputs a result thereof. This output is Y(n)=Z(n)R(n)*.

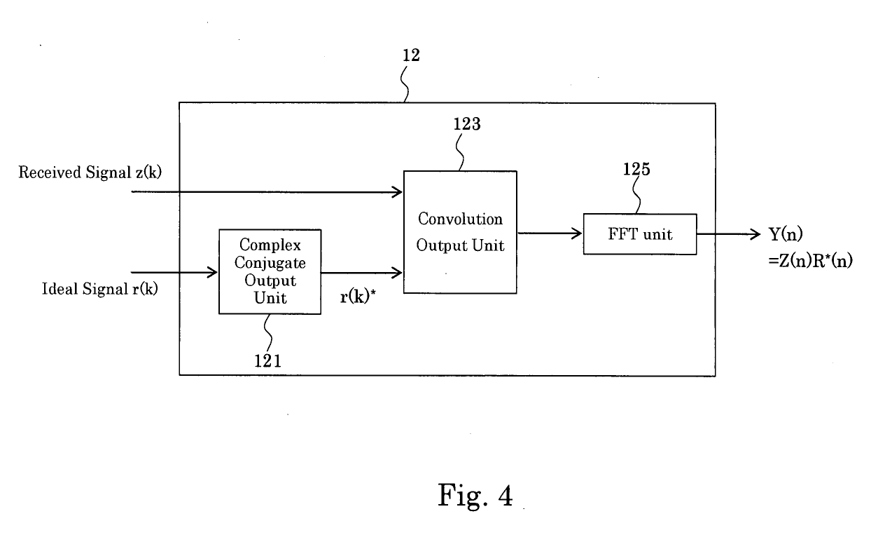

A variation of the configuration of the frequency component product output unit 12 is shown in FIG. 4. As shown in FIG. 4, the frequency component product output unit 12 includes a complex conjugate output unit 121, a convolution output unit 123, and an FFT unit (frequency component output means) 125.

The complex conjugate output unit 121 outputs the complex conjugate r(k)* of the ideal signal r(k).

The convolution output unit 123 outputs a convolution of the output r(k)* of the complex conjugate output unit 121 and the received signal z(k).

The FFT unit (frequency component output means) 125 applies the FFT (Fast Fourier Transform) to the output of the convolution output unit 123, and outputs a result thereof. The result of applying the FFT to the output of the convolution output unit 123 is Y(n)=Z(n)R(n)*.

The sum of products output unit 14 outputs a sum of products Ae^{j}^{^{θ}} of the output Y(n) of the frequency component product output unit 12 and the sampling angular frequency Δω.

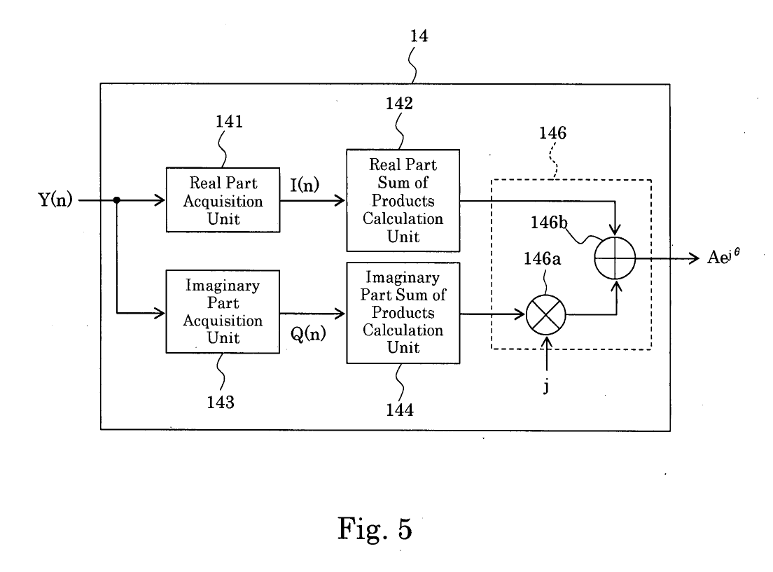

A configuration of the sum of products output unit 14 is shown in FIG. 5. The sum of products output unit 14 includes a real part acquisition unit 141, a real part sum of products calculation unit 142, an imaginary part acquisition unit 143, an imaginary part sum of products calculation unit 144, and a complex number output unit 146.

The real part acquisition unit 141 acquires the real part I(n) of Y(n).

The real part sum of products calculation unit 142 outputs a sum of products of I(n) and the sampling angular frequency Δω. The sum of the products of I(n) and Δω is represented by the following equation (2).

$$\begin{matrix}[ EQU . 2 ] & \\ {\sum }_{n = - N / 2}^{N / 2 - 1} \vert n \vert Δω I ( n ) & ( 2 )\end{matrix}$$

The imaginary part acquisition unit 143 acquires the imaginary part Q(n) of Y(n).

The imaginary part sum of products calculation unit 144 outputs a sum of products of Q(n) and the sampling angular frequency Δω. The sum of the products of Q(n) and Δω is represented by the following equation (3).

$$\begin{matrix}[ EQU . 3 ] & \\ {\sum }_{n = - N / 2}^{N / 2 - 1} n Δω Q ( n ) & ( 3 )\end{matrix}$$

The complex number output unit 146 outputs a complex number whose real part is the output of the real part sum of products calculation unit 142 and whose imaginary part is the output of the imaginary part sum of products calculation unit 144. The output of the complex number output unit 146 is represented as Ae^{j}^{^{θ}}. The complex number output unit 146 includes a multiplier 146a and an adder 146b. The multiplier 146a multiplies the output of the imaginary part sum of products calculation unit 144 by j (j²=−1) to obtain an imaginary number. The adder 146b adds an output of the multiplier 146a to the output of the real part sum of products calculation unit 142. The output of the adder 146b is Ae^{j}^{^{θ}}.

The time delay determining unit 20 determines the time delay τ so as to minimize the error component (EVM) between the ideal signal r(k) and the received signal z(k) based on the output Ae^{j}^{^{θ}} of the multiplication/sum of products output unit 10.

The EVM is obtained by normalizing and then extracting the square root of an error component ε defined by the following equation (4).

$$\begin{matrix}[ EQU . 4 ] & \\ \begin{matrix}ɛ = {\sum }_{k = 0}^{N - 1} {\vert z ( k - τ ) - r ( k ) \vert}^{2} \\ = {\sum }_{k = 0}^{N - 1} {\vert z ( k - τ ) \vert}^{2} + {\sum }_{k = 0}^{N - 1} {\vert r ( k ) \vert}^{2} - 2 Re [ {\sum }_{k = 0}^{N - 1} z ( k - τ ) {r}^{*} ( k ) ]\end{matrix} & ( 4 )\end{matrix}$$

Thus, the error component ε is minimized to minimize the EVM. When the error component ε is minimized, the following equation (5) holds. Namely, a partial derivative of the error component ε with respect to the time delay τ is 0 (zero).

$$\begin{matrix}[ EQU . 5 ] & \\ \frac{\partial ɛ}{\partial τ} = 0 & ( 5 )\end{matrix}$$

There thus can be obtained a time delay τ which minimize the EVM by solving the equation (5) for the time delay τ. An equation (6) is obtained by solving the equation (5) for the time delay τ (proof is provided later).

$$\begin{matrix}[ EQU . 6 ] & \\ τ = \frac{4 θ}{Δω N} & ( 6 )\end{matrix}$$

Thus, the time delay determining unit 20 can determine the time delay τ based on the argument θ of the output Ae^{j}^{^{θ}} of the multiplication/sum of products output unit 10, the sampling angular frequency Δω, and the EVM calculation length N.

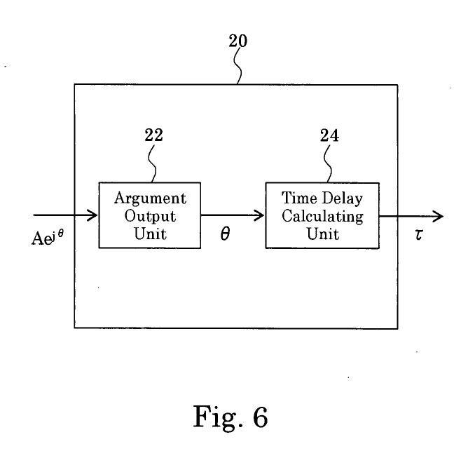

A configuration of the time delay determining unit 20 is shown in FIG. 6. The time delay determining unit 20 includes an argument output unit 22 and a time delay calculating unit 24.

The argument output unit 22 receives the output Ae^{j}^{^{θ}} of the multiplication/sum of products output unit 10, and outputs the argument θ thereof. The time delay calculating unit 24 calculates the time delay τ based on the output θ of the argument output unit 22, the sampling angular frequency Δω, and the error calculation length N. Specifically, the time delay τ is calculated by assigning θ, Δω, and N to the right side of the equation (6). The time delay τ determined in this way makes the equation (5) hold, and thus minimizes the error component ε. Thus, the error component (EVM) can be minimized.

A description will now be given of an operation of the embodiment of the present invention.

First, the ideal signal r(k) is generated from the received signal z(k). The received signal z(k) and the ideal signal r(k) are supplied to the frequency component product output unit 12 of the multiplication/sum of products output unit 10. The frequency component product output unit 12 outputs Y(n)=Z(n)R(n)*. The sum of products output unit 14 obtains the sum of the products of Y(n) and the sampling angular frequency Δω, and outputs the result as Ae^{j}^{^{θ}}.

The resulting sum of products Ae^{j}^{^{θ}} is supplied to the time delay determining unit 20. The time delay determining unit 20 calculates the time delay τ based on the argument θ of Ae^{j}^{^{θ}}, the sampling angular frequency Δω, and the EVM calculation length N. The determined time delay τ can minimize EVM.

According to the present embodiment, it is possible to determine the time delay τ according to the frequency components (Z(n), R(n)) of the received signal z(k) and the ideal signal r(k). Then, it is possible to estimate the symbol points of the received signal z(k) according to the time delay τ. Since the frequency components (Z(n), R(n)) are used on this occasion, it is possible to more precisely estimate the symbol points of the received signal z(k) compared with the conventional case where the temporal components (z(k), r(k)) are used.

Moreover, the above-described embodiment may be realized in the following manner. Namely, a computer is provided with a CPU, a hard disk, and a media (such as a floppy disk (registered trade mark) and a CD-ROM) reader, and the media reader is caused to read a medium recording a program realizing the above-described respective parts (such as the multiplication/sum of products output unit 10 and the time delay determining unit 20), thereby installing the program on the hard disk. This method may also realize the above-described functions.

[Proof of Obtainment of Equation (6) from Equation (5)]

First, the error component ε is represented by the frequency component R(n) of the ideal signal, and the frequency component Z(n) of the received signal.

First, discrete Fourier transform pairs of z and r are represented as: z(k) [symbol] Z(n) and r(k) [symbol] R(n). On this occasion, the following equation (7) holds according to Parseval's equality.

$$\begin{matrix}[ EQU . 7 ] & \\ \begin{matrix}{\sum }_{k = 0}^{N - 1} {\vert z ( k ) \vert}^{2} = \frac{1}{N} {\sum }_{n = 0}^{N - 1} {\vert Z ( n ) \vert}^{2} \\ {\sum }_{k = 0}^{N - 1} {\vert r ( k ) \vert}^{2} = \frac{1}{N} {\sum }_{n = 0}^{N - 1} {\vert R ( n ) \vert}^{2} \\ {\sum }_{k = 0}^{N - 1} z ( k ) {r}^{*} ( k ) = \frac{1}{N} {\sum }_{n = 0}^{N - 1} Z ( n ) {R}^{*} ( n )\end{matrix} \} & ( 7 )\end{matrix}$$

On this occasion, for Z(n) and R(n), Z(n)=Z(n−N) and R(n)=R(n−N) hold, and the equation (7) is thus rewritten as the following equation (8).

$$\begin{matrix}[ EQU . 8 ] & \\ \begin{matrix}{\sum }_{k = 0}^{N - 1} {\vert z ( k ) \vert}^{2} = \frac{1}{N} {\sum }_{n = - N / 2}^{N / 2 - 1} {\vert Z ( n ) \vert}^{2} \\ {\sum }_{k = 0}^{N - 1} {\vert r ( k ) \vert}^{2} = \frac{1}{N} {\sum }_{n = - N / 2}^{N / 2 - 1} {\vert R ( n ) \vert}^{2} \\ {\sum }_{k = 0}^{N - 1} z ( k ) {r}^{*} ( k ) = \frac{1}{N} {\sum }_{n = - N / 2}^{N / 2 - 1} Z ( n ) {R}^{*} ( n )\end{matrix} \} & ( 8 )\end{matrix}$$

Moreover the following equation (9) holds according to the time shifting theorem.

[EQU. 9]
z(k−τ) [symbol] e^{-jnΔωτ}Z(n) (9)

When the equations (8) and (9) are assigned to the equation (4) which defines the error component ε, the following equation (10) is obtained.

$$\begin{matrix}[ EQU . 10 ] & \\ \begin{matrix}ɛ = {\sum }_{k = 0}^{N - 1} {\vert z ( k - τ ) \vert}^{2} + {\sum }_{k = 0}^{N - 1} {\vert r ( k ) \vert}^{2} - 2 Re [ {\sum }_{k = 0}^{N - 1} z ( k - τ ) {r}^{*} ( k ) ] \\ = \frac{1}{N} {\sum }_{n = - N / 2}^{N / 2 - 1} {\vert {ⅇ}^{- j n Δ ω τ} Z ( n ) \vert}^{2} + \frac{1}{N} {\sum }_{n = - N / 2}^{N / 2 - 1} {\vert R ( n ) \vert}^{2} - \\ \frac{2}{N} Re [ {\sum }_{n = - N / 2}^{N / 2 - 1} {ⅇ}^{- j n Δ ωτ} Z ( n ) {R}^{*} ( n ) ] \\ = \frac{1}{N} {\sum }_{n = - N / 2}^{N / 2 - 1} {\vert Z ( n ) \vert}^{2} + \frac{1}{N} {\sum }_{n = - N / 2}^{N / 2 - 1} {\vert R ( n ) \vert}^{2} - \\ \frac{2}{N} Re [ {\sum }_{n = - N / 2}^{N / 2 - 1} {ⅇ}^{- j n Δ ωτ} Z ( n ) {R}^{*} ( n ) ] \\ = \frac{1}{N} {\sum }_{n = - N / 2}^{N / 2 - 1} {\vert Z ( n ) \vert}^{2} + \frac{1}{N} {\sum }_{n = - N / 2}^{N / 2 - 1} {\vert R ( n ) \vert}^{2} - \\ \frac{2}{N} Re [ {\sum }_{n = - N / 2}^{N / 2 - 1} {ⅇ}^{- j n Δ ωτ} Y ( n ) ]\end{matrix} & ( 10 )\end{matrix}$$

Then, a third term of the equation (10) is transformed to obtain the following equation (11).

$$\begin{matrix}[ EQU . 11 ] & \\ [ {\sum }_{n = - N / 2}^{N / 2 - 1} {ⅇ}^{- j n Δ ωτ} Y ( n ) ] = Re [ \begin{matrix}{\sum }_{n = - N / 2}^{N / 2 - 1} {ⅇ}^{- j n Δ ωτ} Y ( n ) + \\ {\sum }_{n = 0}^{N / 2 - 1} {ⅇ}^{- j n Δ ωτ} Y ( n )\end{matrix} {\sum }_{n = 0}^{N / 2 - 1} {ⅇ}^{- j n Δ ωτ} Y ( n ) ] & ( 11 )\end{matrix}$$

The equation (11) represents a relationship among terms of the real part, and does not include terms of the imaginary part. Thus, even for complex conjugates of respective terms of the equation (11), the equation (11) still holds. The following equation (12) is thus obtained by replacing the first term on the right side of the equation (11) by the complex conjugate thereof, and then transforming the equation (11).

$$\begin{matrix}[ EQU . 12 ] & \\ \begin{matrix}Re [ {\sum }_{n = - N / 2}^{N / 2 - 1} {ⅇ}^{- j n Δ ω τ} Y ( n ) ] = Re [ \begin{matrix}{\sum }_{n = - N / 2}^{- 1} {\{ {ⅇ}^{- j n Δ ω τ} Y ( n ) \}}^{*} + \\ {\sum }_{n = 0}^{ N / 2 - 1} {ⅇ}^{- j n Δ ω τ} Y ( n )\end{matrix} ] \\ = Re [ \begin{matrix}{\sum }_{n = - N / 2}^{- 1} {ⅇ}^{j n Δ ω τ} {Y}^{*} ( n ) + \\ {\sum }_{n = 0}^{ N / 2 - 1} {ⅇ}^{- j n Δ ω τ} Y ( n )\end{matrix} ] \\ = Re [ \begin{matrix}{\sum }_{n = 1}^{N / 2} {ⅇ}^{- j n Δ ω τ} {Y}^{*} ( - n ) + \\ {\sum }_{n = 0}^{ N / 2 - 1} {ⅇ}^{- j n Δ ω τ} Y ( n )\end{matrix} ]\end{matrix} & ( 12 )\end{matrix}$$

When the equation (12) is assigned to the equation (10), the error component ε is represented by the following equation (13).

$$\begin{matrix}[ EQU . 13 ] & \\ ɛ = \frac{1}{N} {\sum }_{n = - N / 2}^{N / 2 - 1} {\vert Z ( n ) \vert}^{2} + \frac{1}{N} {\sum }_{n = - N / 2}^{N / 2 - 1} {\vert R ( n ) \vert}^{2} - \frac{2}{N} Re [ \begin{matrix}{\sum }_{n = 1}^{N / 2} {ⅇ}^{- j n Δ ω τ} {Y}^{*} ( - n ) + \\ {\sum }_{n = 0}^{N / 2 - 1} {ⅇ}^{- j n Δ ω τ} Y ( n ) b\end{matrix} ] & ( 13 )\end{matrix}$$

There is then obtained the value (left side of the equation (5)) which is the partial derivative of the error component ε with respect to the time delay τ.

The value obtained by partially differentiating the error component ε by the time delay τ is represented by the following equation (14).

$$\begin{matrix}[ EQU . 14 ] & \\ \begin{matrix}\frac{\partial ɛ}{\partial τ} = - \frac{2}{N} \frac{\partial R e [ \begin{matrix}{\sum }_{n = 1}^{N / 2} {ⅇ}^{- j n Δ ω τ} {Y}^{*} ( - n ) + \\ {\sum }_{n = 0}^{N / 2 - 1} {ⅇ}^{- j n Δ ω τ} Y ( n )\end{matrix} ]}{\partial τ} \\ = - \frac{2}{N} Re [ \begin{matrix}{\sum }_{n = 1}^{N / 2} {ⅇ}^{- j n Δ ω τ} ( - j n Δ ω ) {Y}^{*} ( - n ) + \\ {\sum }_{n = 0}^{ N / 2 - 1} {ⅇ}^{- j n Δ ω τ} ( - j n Δ ω ) Y ( n )\end{matrix} ] \\ = - \frac{2}{N} Im [ \begin{matrix}{\sum }_{n = 1}^{N / 2} {ⅇ}^{- j n Δ ω τ} n Δ ω {Y}^{*} ( - n ) + \\ {\sum }_{n = 0}^{N / 2 - 1} {ⅇ}^{- j n Δ ω τ} n Δ ω Y ( n )\end{matrix} ]\end{matrix} & ( 14 )\end{matrix}$$

On this occasion, the time delay τ is small to a certain extent, and a relationship represented by the following equation (15) holds for n=0 to N/2.

$$\begin{matrix}[ EQU . 15 ] & \\ n Δ ω τ = \frac{N}{4} Δ ω τ & ( 15 )\end{matrix}$$

The following equation (16) is obtained by assigning the equation (14) to the equation (15).

$$\begin{matrix}[ EQU . 16 ] & \\ \begin{matrix}\frac{\partial ɛ}{\partial τ} = - \frac{2}{N} Im [ {ⅇ}^{- j \frac{N}{4} Δ ω τ} \{ \begin{matrix}{\sum }_{n = 1}^{N / 2} n Δ ω {Y}^{*} ( - n ) + \\ {\sum }_{n = 0}^{N / 2 - 1} n Δ ω Y ( n )\end{matrix} \} ] \\ = - \frac{2}{N} Im [ {ⅇ}^{- j \frac{N}{4} Δ ω τ} \{ \begin{matrix}{\sum }_{n = - N / 2}^{N / 2} \vert n \vert Δ ω I ( n ) + \\ j {\sum }_{n = - N / 2}^{N / 2} n Δ ω Q ( n )\end{matrix} \} ]\end{matrix} & ( 16 )\end{matrix}$$

According to the definition of the sum of products output unit 14, the following equation (17) holds.

$$\begin{matrix}[ EQU . 17 ] & \\ {\sum }_{n = - N / 2}^{N / 2} \vert n \vert Δ ω I ( n ) + j {\sum }_{n = - N / 2}^{N / 2} n Δ ω Q ( n ) ≡ A {ⅇ}^{j θ} & ( 17 )\end{matrix}$$

The equation (16) can thus be rewritten as the following equation (18).

$$\begin{matrix}[ EQU . 18 ] & \\ \begin{matrix}\frac{\partial ɛ}{\partial τ} = - \frac{2}{N} Im [ {ⅇ}^{- j \frac{N}{4} Δ ω τ} A {ⅇ}^{j θ} ] \\ = - \frac{2}{N} Im [ A {ⅇ}^{- j ( \frac{N}{4} Δ ω τ - θ )} ]\end{matrix} & ( 18 )\end{matrix}$$

There is finally to be obtained such τ that a partial derivative of the error component ε with respect to the time delay τ is 0.

It is necessary that the following equation (19) holds in order to cause the equation (18) to be 0. This is because the imaginary part is 0 if the argument of a complex number is 0°.

$$\begin{matrix}[ EQU . 19 ] & \\ \frac{N}{4} Δ ω τ - θ = 0 & ( 19 )\end{matrix}$$

The following equation (20) is obtained by solving the equation (19) with respect to τ.

$$\begin{matrix}[ EQU . 20 ] & \\ τ = \frac{4 θ}{Δ ω N} & ( 20 )\end{matrix}$$

The equation (20) is the same as the equation (6).

Thus, it is possible to obtain the equation (6) from the equation (5).

1. A symbol point estimating apparatus that estimates a symbol point of a received signal by determining a time delay between a sampling point of the received signal sampled at a sampling frequency, and the symbol point of the received signal, comprising:
a multiplication/sum of products outputter that outputs a sum of products of respective products obtained by multiplying a complex conjugate of a frequency component of an ideal signal and a frequency component of the received signal and a sampling angular frequency; and
a time delay determiner that determines a time delay to minimize an error component between the ideal signal and the received signal based on the output of said multiplication/sum of products outputter.

2. The symbol point estimating apparatus according to claim 1, wherein:
said multiplication/sum of products outputter comprises:
a frequency component product outputter that outputs the product of the complex conjugate of the frequency component of the ideal signal and the frequency component of the received signal; and
a sum of products outputter that outputs the sum of products of the respective outputs of said frequency component product outputter and the sampling angular frequency.

3. The symbol point estimating apparatus according to claim 2, wherein:
said frequency component product outputter comprises:
an ideal signal frequency component outputter that outputs the frequency component of the ideal signal;
a received signal frequency component outputter that outputs the frequency component of the received signal;
a complex conjugate outputter that outputs the complex conjugate of the output of said ideal signal frequency component outputter; and
a frequency component product outputter that multiplies the output of said complex conjugate outputter and the output of said received signal frequency component outputter by each other, and then outputs a result of the multiplication.

4. The symbol point estimating apparatus according to claim 2, wherein:
said frequency component product outputter comprises:
a convolution outputter that outputs a convolution of the complex conjugate of the ideal signal and the received signal; and
a frequency component outputter that outputs a frequency component of the output of said convolution outputter .

5. The symbol point estimating apparatus according to claim 2, wherein:
said sum of products outputter comprises:
a real part sum of products outputter that outputs a sum of products of the real part of the respective outputs of said frequency component product outputter and the sampling angular frequency;
an imaginary part sum of products outputter that outputs a sum of products of the imaginary part of the respective outputs of said frequency component product outputter and the sampling angular frequency; and
a complex number outputter that outputs a complex number whose real part is the output of said real part sum of products outputter and whose imaginary part is the output of said imaginary part sum of products outputter.

6. The symbol point estimating apparatus according to claim 1, wherein:
said time delay determiner determines the time delay based on the argument of the output of said multiplication/sum of products outputter, the sampling angular frequency, and an error calculation length which is the number of the components of the received signal used to calculate the error component.

7. The symbol point estimating apparatus according to claim 6, wherein:
said time delay determiner comprises:
an argument outputter that receives the output of said multiplication/sum of products outputter, and outputs the argument thereof; and
a time delay calculator that calculates the time delay based on the output of said argument outputter, the sampling angular frequency, and the error calculation length.

8. A symbol point estimating method that estimates a symbol point of a received signal by determining a time delay between a sampling point of the received signal sampled at a sampling frequency, and the symbol point of the received signal, comprising:
outputting a sum of products of respective products obtained by multiplying a complex conjugate of a frequency component of an ideal signal and a frequency component of the received signal and a sampling angular frequency; and
determining step of determining a time delay to minimize an error component between the ideal signal and the received signal based on the output sum of products.

9. A program of instructions for execution by a computer to perform a symbol point estimating process that estimates a symbol point of a received signal by determining a time delay between a sampling point of the received signal sampled at a sampling frequency, and the symbol point of the received signal, said symbol point estimating process comprising:
outputting a sum of products of respective products obtained by multiplying a complex conjugate of a frequency component of an ideal signal and a frequency component of the received signal and a sampling angular frequency; and
determining a time delay to minimize an error component between the ideal signal and the received signal based on the output sum of products.

10. A computer-readable medium having a program of instructions for execution by a computer to perform a symbol point estimating process that estimates a symbol point of a received signal by determining a time delay between a sampling point of the received signal sampled at a sampling frequency, and the symbol point of the received signal, said symbol point estimating process comprising:
outputting a sum of products of respective products obtained by multiplying a complex conjugate of a frequency component of an ideal signal and a frequency component of the received signal and a sampling angular frequency; and
determining a time delay to minimize an error component between the ideal signal and the received signal based on the output sum of products.
